(19) United States
(12) Patent Application Publication
(10) Pub. No.: US 2024/0396029 A1
(43) Pub. Date: Nov. 28, 2024

(54) NEGATIVE ELECTRODE MIXTURE, LITHIUM ION BATTERY

(71) Applicant: TOYOTA JIDOSHA KABUSHIKI KAISHA, Toyota-shi Aichi-ken (JP)

(72) Inventor: Azusa Nakanishi, Susono-shi Shizuoka-ken (JP)

(73) Assignee: TOYOTA JIDOSHA KABUSHIKI KAISHA, Toyota-shi Aichi-ken (JP)

(21) Appl. No.: 18/667,558

(22) Filed: May 17, 2024

(30) Foreign Application Priority Data
May 22, 2023 (JP) 2023-083877

(51) Int. Cl. H01M 4/38; H01M 4/02; H01M 4/134; H01M 4/137; H01M 4/36; H01M 4/60; H01M 4/62

(52) U.S. Cl. CPC H01M 4/386; H01M 4/134; H01M 4/137; H01M 4/366; H01M 4/606; H01M 4/625; H01M 2004/027

(57) ABSTRACT

The present disclosure provides a negative electrode mixture comprising a carbon nanotube as a conductive aid and with a small resistance, and a lithium ion battery comprising such a negative electrode mixture. The negative electrode mixture of the present disclosure comprises a surface-modified negative electrode active material particles and a conductive aid. The surface-modified negative electrode active material particles comprised in the negative electrode mixture of the present disclosure have silicon particles and an aromatic group modifying the surface of the silicon particles. The conductive aid comprised in the negative electrode mixture of the present disclosure comprises a carbon nanotube. The lithium ion battery of the present disclosure comprises a negative electrode active material layer, and the negative electrode active material layer contains the negative electrode mixture of the present disclosure.

### CROSS-REFERENCE TO RELATED APPLICATIONS

This application claims priority to Japanese Patent Application No. 2023-083877 filed May 22, 2023, the entire contents of which are herein incorporated by reference.

### FIELD

The disclosure relates to a negative electrode mixture, a lithium ion battery.

### BACKGROUND

In recent years, there has been ongoing development of batteries. For example, in the automotive industry, the development of batteries for use in electric vehicles or hybrid vehicles has been advancing. In addition, silicon is known as an electrode active material used in batteries.

In this regard, it has been proposed to use carbon nanotubes as a conductive aid to reduce the resistance of the active material layer.

For example, PTL 1 discloses a negative electrode material for a lithium ion secondary battery comprising a silicon particles and a carbon nanofiber, in which the carbon nanofiber is SiC nanowire and/or multi-walled carbon nanotube.

### [CITATION LIST]

### [PATENT LITERATURE]

[PTL 1] Japanese Unexamined Patent Publication (Kokai) No. 2012-252845

### SUMMARY

### [TECHNICAL PROBLEM]

In lithium ion batteries using carbon nanotubes as a conductive aid comprised in the negative electrode mixture, it is desired to further reduce the resistance.

An object of the present disclosure is to provide a negative electrode mixture comprising a carbon nanotube as a conductive aid and with a small resistance, and a lithium ion battery comprising such a negative electrode mixture.

[SOLUTION TO PROBLEM]

The present inventors have discovered that the above object can be achieved by the following techniques.

### <Aspect 1>

A negative electrode mixture,
wherein the negative electrode mixture comprises a surface-modified negative electrode active material particles and a conductive aid,
wherein the surface-modified negative electrode active material particles have silicone particles and an aromatic group modifying the surface of the silicone particles, and
wherein the conductive aid comprises a carbon nanotube.

### <Aspect 2>

The negative electrode mixture according to Aspect 1, wherein the aromatic group is a monocyclic aryl group.

### <Aspect 3>

The negative electrode mixture according to Aspect 1 or 2, wherein the number of carbons of the aromatic group is 4 or more and 10 or less.

### <Aspect 4>

The negative electrode mixture according to any one of Aspects 1 to 3, wherein the surface-modified negative electrode active material particles have a silicon-oxygen-silicon-carbon bond, the silicon not bonded to the carbon is silicon of the silicon particles, and the carbon is carbon of the aromatic group.

### <Aspect 5>

A lithium ion battery,
wherein the lithium ion battery comprises a negative electrode active material layer,
wherein the negative electrode active material layer contains the negative electrode mixture according to any one of Aspects 1 to 4.

### [EFFECTS OF PRESENT DISCLOSURE]

According to the present disclosure, a negative electrode mixture comprising a carbon nanotube as a conductive aid and with a small resistance, and a lithium ion battery comprising such a negative electrode mixture can be provided.

### BRIEF DESCRIPTION OF DRAWINGS

FIG. 1 is a schematic cross-sectional view showing an example of a lithium ion battery of the present disclosure.

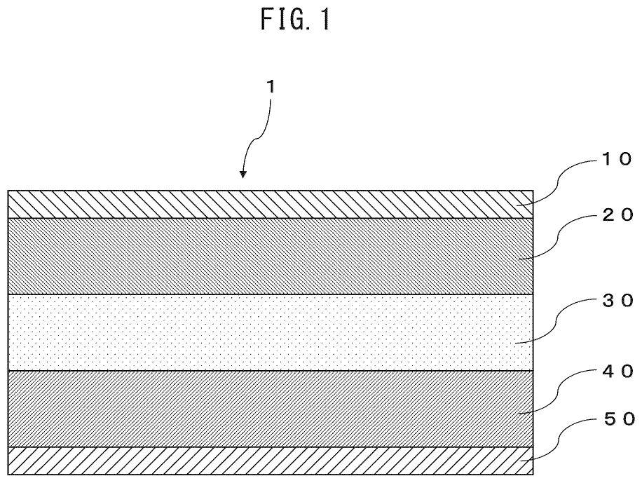

### DESCRIPTION OF EMBODIMENTS

Hereinafter, embodiments of the present disclosure will be described in detail. It should be noted that the present disclosure is not limited to the following embodiments, and various modifications can be made thereto within the scope of the disclosure.

### <<Negative Electrode Mixture>>

The negative electrode mixture of the present disclosure comprises a surface-modified negative electrode active material particles and a conductive aid. The surface-modified negative electrode active material particles comprised in the negative electrode mixture of the present disclosure have silicon particles and an aromatic group modifying the surface of the silicon particles. The conductive aid comprised in the negative electrode mixture of the present disclosure comprises a carbon nanotube.

The present inventors have found that the original conductivity of carbon nanotubes may not be sufficiently exerted due to agglomeration of the carbon nanotubes in batteries in which negative electrode mixtures comprise silicone particles and the carbon nanotubes as a conductive aid.

In contrast, the present inventors have found that the resistance of batteries can be reduced by surface modification of silicone particles with an aromatic group. Without intending to be bound by any theory, the reason therefor is considered that surface modification of the silicone particles with the aromatic group improves the dispersibility of carbon nanotubes in negative electrode mixtures. Specifically, it is considered that x-x interaction occurs between aromatic rings modifying the silicone particles and the carbon nanotubes, thereby improving the dispersibility of the carbon nanotubes and suppressing the aggregation of the carbon nanotubes.

A “negative electrode mixture” relating to the present disclosure means a composition that can constitute a negative electrode active material layer as-is or by further containing an additional component. In addition, a “negative electrode mixture slurry” means a slurry that comprises a dispersion medium in addition to the ““ negative electrode mixture” and can be applied and dried to form a negative electrode active material layer.

### <Surface-Modified Negative Electrode Active Material Particles>

The negative electrode mixture of the present disclosure comprises a surface-modified negative electrode active material particles.

### (Silicone Particles)

The surface-modified negative electrode active material particles have silicon particles.

The composition of the silicon particles is not particularly limited. The ratio of the silicon element to all elements comprised in the silicon particles may be, for example, 50 mol % or more, 70 mol % or more, or 90 mol % or more.

The silicon particles may comprise other elements, such as Li element, in addition to Si element. Examples of other elements include, in addition to Li element, Sn element, Fe element, Co element, Ni element, Ti element, Cr element, B element, and P element.

The silicon particles may comprise impurities such as oxides.

The silicon particles may be amorphous or crystalline. The crystalline phase comprised in the silicone particles is not particularly limited.

The shape and size of silicone particles are not particularly limited. The average particle diameter of the silicon particles may be, for example, 30 nm or more, 50 nm or more, 100 nm or more, or 150 nm or more, and may be 10 μm or less, 5 μm or less, 3 μm or less, 2 μm or less, or 1 μm or less. The average particle diameter can be determined by observation using an electron microscopy such as SEM, and is determined, for example, as the average value of the maximum Feret diameters of each of a plurality of particles. In some embodiments, the number of samples is large, for example, 20 or more, may be 50 or more, or may be 100 or more. The average particle diameter can be adjusted accordingly by, for example, changing the manufacturing conditions of silicone particles described below, or performing a classification treatment.

The silicon particles comprised in the surface-modified negative electrode active material particles may be porous silicon particles. Porous silicone particles contain silicon having a plurality of voids. There is no particular limitation in the form of voids in the porous silicone particles.

The porous silicone particles may be particles comprising nanoporous silicone. Nanoporous silicone refers to silicone in which a plurality of pores having a pore diameter on the nanometer order (less than 1000 nm, or 100 nm or less).

### (Aromatic Group)

The surface-modified negative electrode active material particles have an aromatic group modifying the surface of the silicon particles.

In the present disclosure, an “aromatic group” means a functional group having aromaticity, and may be a monocyclic aromatic group or a polycyclic aromatic group. In addition, in the present disclosure, the “aromatic group” may be an aryl group or a heteroaryl group.

Examples of the monocyclic aryl group include an optionally substituted phenyl group, an optionally substituted biphenyl group, and an optionally substituted triphenyl group. Examples of the polycyclic aryl group include an optionally substituted naphthyl group and an optionally substituted anthracenyl group.

Examples of the monocyclic heteroaryl group include thienyl group, furyl group, pyrrole group, thiazole group, oxazole group, pyrazole group, and pyridyl group. Examples of the polycyclic heteroaryl group include a benzothienyl group, a benzofuryl group, and an indole group.

The number of carbons of the aromatic group may be 4 or more and 10 or less. The number of carbons may be 5 or more, or 6 or more, and may be 9 or less, 8 or less, or 7 or less.

In some embodiments, the aromatic group is a monocyclic aryl group of which the number of carbons 4 or more and 10 or less. Examples of such an aromatic group include a phenyl group and a tolyl group.

The surface-modified negative electrode active material particles may have a silicon-oxygen-silicon-carbon bond, and the silicon not bonded to the carbon may be silicon of the silicon particles and the carbon may be carbon of the aromatic group. In other words, the carbon of the aromatic group may be bonded to the silicon on the surface of the silicon particles via oxygen and silicon.

<Method for Manufacturing Surface-Modified Negative Electrode Active Material Particles>

The method of the present disclosure for manufacturing surface-modified negative electrode active material particles includes modifying the surface of the silicon particles with an aromatic group.

The surface of the silicon particles may be modified with an aromatic group by dehydration condensation between the silanol group on the surface of the silicon particles and the silanol group generated by hydrolyzing a hydrolyzable group-containing silane having an aromatic group.

As the hydrolyzable group-containing silane, a hydrolyzable group-containing silane having a corresponding structure can be used with reference to the above description regarding the aromatic group of the present disclosure.

### <Conductive Aid>

The negative electrode mixture of the present disclosure comprises a conductive aid. The conductive aid comprises a carbon nanotube.

Examples of the carbon nanotube include single-walled carbon nanotube (SWCNT) and multi-walled carbon nanotube (MWCNT). In some embodiments, carbon nanotube is SWCNT.

The negative electrode mixture of the present disclosure optionally comprises an electrolyte, a conductive aid other than carbon nanotubes, and a binder.

### <Electrolyte>

The material of the solid electrolyte is not particularly limited, and any material usable as a solid electrolyte used in lithium ion batteries can be used. For example, the solid electrolyte may be a sulfide solid electrolyte.

Examples of the sulfide solid electrolyte include, but are not limited to, sulfide amorphous solid electrolytes, sulfide crystalline solid electrolytes, and argyrodite-type solid electrolytes. Specific examples of the sulfide solid electrolyte can include, but are not limited to, Li₂S—P₂S₅-based (such as Li₇P₃S₁₁, Li₃PS₄, and Li₈P₂S₉), Li₂S—SiS₂, LiI—Li₂S—SiS₂, LiI—Li₂S—P₂S₅, LiI—LiBr-Li₂S—P2S₅, Li₂S—P₂S₅—GeS₂ (such as Li₁₃GeP₃S₁₆ and Li₁₀GeP₂S₁₂), LiI—Li₂S—P₂O₅, LiI—Li₃PO₄—P₂S₅, and Li₇₋ₓPS₆₋ₓClₓ; and combinations thereof.

The sulfide solid electrolyte may be glass or crystallized glass (glass ceramics).

In some embodiments, when the negative electrode mixture comprises a solid electrolyte, the mass ratio (mass of surface-modified negative electrode active material particles: mass of solid electrolyte) of the surface-modified negative electrode active material particles to the solid electrolyte in the negative electrode mixture is 85:15 to 30:70, or 80:20 to 40:60.

In some embodiments, the electrolytic solution contains supporting salt of the electrolytic solution and a solvent.

Examples of the supporting salt (lithium salt) of the electrolytic solution having lithium-ion conducting properties include inorganic lithium salts such as LiPF6, LiBF4, LiCIO4, and LiAsF6; and organic lithium salts such as LiCF₃ SO₃, LIN(CF₃ SO₂)₂, LIN(C₂F₅SO₂)₂, LIN(FSO₂)₂, and LiC(CF₃ SO₂)₃.

Examples of the solvent used in the electrolytic solution include cyclic esters (cyclic carbonates) such as ethylene carbonate (EC), propylene carbonate (PC), and butylene carbonate (BC); and chain esters (chain carbonates) such as dimethyl carbonate (DMC), diethyl carbonate (DEC), and ethyl methyl carbonate (EMC). In some embodiments, the electrolytic solution contains two or more solvents.

### <Conductive Aid Other Than Carbon Nanotubes>

Conductive aid other than carbon nanotubes is not particularly limited. For example, the conductive aid may be, but is not limited to, VGCF (vapor grown carbon fiber), acetylene black (AB), ketjen black (KB), or carbon nanofiber (CNF). The ratio of the conductive aid other than carbon nanotubes to the total mass of the conductive aid may be less than 50% by mass, less than 40% by mass, less than 30% by mass, less than 20% by mass, or less than 10% by mass, and may be 0% by mass.

### <Binder>

The binder is not particularly limited. For example, the binder may be, but is not limited to, a material such as polyvinylidene fluoride (PVdF), butadiene rubber (BR), or styrene butadiene rubber (SBR), or a combination thereof.

### <<Lithium Ion Battery>>

The lithium ion battery 1 of the present disclosure comprises a negative electrode active material layer 40, and the negative electrode active material layer contains the negative electrode mixture of the present disclosure. The lithium ion battery of the present disclosure may have a negative electrode current collector layer 50, a negative electrode active material layer 40 containing the negative electrode mixture of the present disclosure, a solid electrolyte layer 30, a positive electrode active material layer 20, and a positive electrode current collector layer 10 in this order.

The lithium ion battery of the present disclosure may be a liquid-based battery containing an electrolytic solution as an electrolyte layer, and may be a solid-state battery having a solid electrolyte layer as an electrolyte layer. The “solid-state battery” relating to the present disclosure means a battery using at least a solid electrolyte as the electrolyte, and therefore the solid-state battery may use a combination of a solid electrolyte and a liquid electrolyte as the electrolyte. In addition, the solid-state battery of the present disclosure may be an all-solid-state battery, i.e., a battery using only a solid electrolyte as the electrolyte.

The lithium ion battery may be a primary battery or a secondary battery.

The shape of the lithium ion battery, for example, coin-type, laminate-type, cylindrical-type, square-type.

### <Negative Electrode Current Collector Layer>

The material used for the negative electrode current collector layer is not particularly limited. Any material that can be used as a negative electrode current collector of a battery can be appropriately adopted. For example, the material may be, but is not limited to, copper, copper alloy, or copper plated or vapor-deposited with nickel, chromium, or carbon.

The shape of the negative electrode current collector layer is not particularly limited, and can include, for example, foil-like, plate-like, or mesh-like. Among these, in some embodiments, a foil-like shape is selected.

### <Negative Electrode Active Material Layer>

The negative electrode active material layer of the present disclosure contains the negative electrode mixture of the present disclosure. The above descriptions relating to the negative electrode mixture of the present disclosure can be referenced regarding the negative electrode mixture.

In some embodiments, the thickness of the negative electrode active material layers is, for example, 0.1 μm to 1000 μm, 1 μm to 100 μm, or 30 μm to 100 μm.

### <Electrolyte Layer>

The electrolyte layer comprises at least an electrolyte. In addition, the electrolyte layer may comprise a binder in addition to the electrolyte, as needed. The above descriptions relating to the negative electrode mixture of the present disclosure can be referenced regarding the electrolyte and the binder.

In some embodiments, the thickness of the electrolyte layer is, for example, 0.1 to 300 μm, or 0.1 to 100 μm.

### <Positive Electrode Active Material Layer>

The positive electrode active material layer is a layer containing a positive electrode active material and optionally a solid electrolyte, a conductive aid, and a binder.

The material of the positive electrode active material is not particularly limited. For example, the positive electrode active material may be, but is not limited to, lithium cobaltate (LiCoO₂), lithium nickelate (LiNiO₂), lithium manganate (LiMn₂O₄), LiCo_{1/3}Ni_{1/3} Mn_{1/3}O₂, a heteroelement-substituted Li-Mn spinel having a composition represented by Li₁₊ₓMn_{2-x-y}M_{y}O₄ (M is one or more metal elements selected from Al, Mg, Co, Fe, Ni, and Zn), lithium titanate (Liₓ TiO_{y}), or lithium metal phosphate (LiMPO₄, where M is one or more metals selected from Fe, Mn, Co, and Ni).

The positive electrode active material can comprise a covering layer. The covering layer is a layer containing a material that has lithium-ion conducting performance, has low reactivity with the positive electrode active material and the solid electrolyte, and can maintain the form of a covering layer that does not flow even when brought into contact with the active material or the solid electrolyte. Specific examples of the material constituting the covering layer can include, but are not limited to, Li₄ Ti₅ O₁₂ and Li₃ PO₄, in addition to LiNbO₃.

Examples of shapes of the positive electrode active material include particulate. The average particle size (D50) of the positive electrode active material is not particularly limited, and for example, is 10 nm or more, and may be 100 nm or more. The average particle size (D50) of the positive electrode active material is, for example, 50 μm or less, and may be 20 μm or less. The average particle size (D50) can be calculated from measurements with, for example, a laser diffraction particle size distribution analyzer or a scanning electron microscope (SEM).

The above descriptions relating to the negative electrode mixture of the present disclosure can be referenced regarding the electrolyte and the binder. Conductive aid other than carbon nanotubes is not particularly limited. For example, the conductive aid may be, but is not limited to, VGCF (vapor grown carbon fiber), acetylene black (AB), ketjen black (KB), or carbon nanofiber (CNF).

In some embodiments, when the positive electrode active material layer contains a solid electrolyte, the mass ratio (mass of positive electrode active material: mass of solid electrolyte) of the positive electrode active material to the solid electrolyte in the positive electrode active material layer is 85:15 to 30:70, or 80:20 to 50:50.

In some embodiments, the thickness of the positive electrode active material layers is, for example, 0.1 μm to 1000 μm, 1 μm to 100 μm, or 30 μm to 100 μm.

### <Positive Electrode Current Collector Layer>

The material used for the positive electrode current collector layer is not particularly limited. Any material that can be used as a positive electrode current collector of a battery can be appropriately adopted. For example, the material may be, but is not limited to, SUS, nickel, chromium, gold, platinum, aluminum, iron, titanium, zinc, or one of these metals plated or vapor-deposited with nickel, chromium, or carbon.

The shape of the positive electrode current collector layer is not particularly limited, and can include, for example, foil-like, plate-like, or mesh-like. Among these, in some embodiments, a foil-like shape is selected.

### EXAMPLES

### <<Fabrication of Surface-Modified Negative Electrode Active Particles>>

### <Preparation of Silicone Particles>

### (Comparative Synthetic Example 1)

As a silicon (Si) source, silicon particles were prepared. The silicon particles and lithium (Li) metal were weighed at a molar ratio of Li/Si=4.0, and the weighed silicon powder and Li were mixed in a mortar in an argon atmosphere to obtain a lithium-silicon (LiSi) alloy. The obtained LiSi alloy was reacted with ethanol in an argon atmosphere to obtain porous silicon particles.

### <Modification by Aromatic Groups>

### (Synthetic Example 1).

Within the argon (Ar)-substituted glove box, 2 g of porous silicone particles, 20 g of super-dehydrated ethanol (manufactured by FUJIFILM Wako Pure Chemical Corporation), and 0.027 g of trimethoxy (p-tolyl) silane (manufactured by Tokyo Chemical Industry Co., Ltd.), which is a silane coupling agent having p-tolyl group (—p-C₆ H₄ (CH₃)) were weighed and placed in a sealed reaction vessel, and stirred at 50° C. for 16 h to dehydrate and condense between the silanol group on the surface of the porous Si and the silanol group generated by hydrolysis of the silane coupling agent having p-tolyl group (—p-C₆ H₄ (CH₃)). After the reaction, the solution was suction filtered, and the operation of washing with 30 mL of ethanol and filtering was repeated 5 times. The obtained solid was vacuum-dried at 100° C. for 12 h to obtain surface-modified negative electrode active material particles in which the surface of silicon particles was modified with p-tolyl group (—p-C₆ H₄ (CH₃)).

### (Synthetic Example 2)

Except that the silane coupling agent was changed to 0.025 g of trimethoxyphenylsilane (manufactured by Tokyo Chemical Industry Co., Ltd.) having a phenyl group (—C₆ H₅), surface-modified negative electrode active material particles were produced by modifying the surface of silicone particles with phenyl group (—C₆ H₅) in the same manner as in Synthetic example 1.

### (Comparative Synthetic Example 2)

Except that the silane coupling agent was changed to 0.06 g of hexyl trimethoxysilane (manufactured by Tokyo Chemical Industry Co., Ltd.) having hexyl group (—(CH₂)₅ CH₃)), surface-modified negative electrode active material particles were produced by modifying the surface of silicone particles with hexyl group (—(CH₂)₅ CH₃)) in the same manner as in Synthetic Example 1.

### <<Production of Battery>>

### <Preparation of Positive Electrode Mixture>

Butyl butyrate, a 5-wt % butyl butyrate solution of a PVDF-based binder, LiNi_{1/3}Co_{1/3}Mn_{1/3}O₂ having an average particle size of 6 μm as the positive electrode active material, a Li₂S—P₂S₅-based glass ceramic as the sulfide solid electrolyte, and VGCF as the conductive aid were added to a polypropylene (PP) container and stirred with an ultrasonic dispersion apparatus (UH-50 manufactured by SMT) for 30 s. The container was then shaken with a shaker (TTM-1 manufactured by Sibata Scientific Technology Ltd.) for 3 min, further stirring was carried out with the ultrasonic dispersion apparatus for 30 s, and the container was shaken with the shaker for 3 min to obtain a slurry-like positive electrode mixture (positive electrode mixture slurry).

### <Formation of Positive Electrode Active Material Layer>

The obtained positive electrode mixture slurry was applied onto an Aluminum (Al) foil (manufactured by Showa Denko Co., Ltd.) as a positive electrode current collector layer by a blade method using an applicator and dried for 30 min on a hot plate heated to 100° C., whereby a positive electrode active material layer was formed on the positive electrode current collector layer.

### <Preparation of Negative Electrode Mixture>

### (Comparative Examples 1 and 2, and Examples 1 and 2)

Diisobutyl ketone, a 5-wt % diisobutyl ketone solution of a PVDF-based binder (manufactured by Kurcha Co., Ltd.: KF8300), single-walled carbon nanotube (SWCNT) (manufactured by sigma-aldrich) as the conductive aid, a Li₂S—P₂S₅-based glass ceramic as the sulfide solid electrolyte, and any one of silicon particles of Comparative Synthetic Examples 1 and 2, and Synthetic examples 1 and 2 as negative electrode active material were added to a container and stirred with an ultrasonic dispersion apparatus (UH-50 manufactured by SMT) for 1 min. The container was then shaken with a shaker (TTM-1 manufactured by Sibata Scientific Technology Ltd.) for 30 min to obtain a slurry-like negative electrode mixture (negative electrode mixture slurry) of Comparative Examples 1 and 2, and Examples 1 and 2. The numbers of the Comparative Synthetic Examples correspond to the numbers of the Comparative Examples, and the numbers of the Synthetic Examples correspond to the numbers of the Examples.

### (Comparative Example 3 and Example 3)

Except that the conductive aid was changed to a multi-walled carbon nanotube (MWCNT) (manufactured by Tokyo Chemical Industry Co., Ltd.), negative electrode mixture slurry of

Comparative Example 3 and Example 3 were prepared in the same manner as in Comparative Example 1 and Example 1.

### (Comparative Examples 4 and 5)

Except that the conductive aid was changed to acetylenic carbon black (AB) (manufactured by FUJIFILM Wako Pure Chemical Corporation), negative electrode mixture slurry of

Comparative Examples 4 and 5 was prepared in the same manner as in Comparative Example 1 and Example 1.

### <Formation of Negative Electrode Active Material Layer>

The obtained negative electrode mixture slurry was applied onto a nickel (Ni) foil as a negative electrode current collector by a blade method using an applicator. Applied slurry was dried for 30 min on a hot plate heated to 100° C. to form a negative electrode active material layer on the negative electrode current collector layer.

### <Formation of Solid Electrolyte Layer>

Heptane, a 5-wt % heptane solution of a 5-wt % heptane solution of an SBR-based binder, and a Li₂S—P₂S₅-based glass ceramic as the sulfide solid electrolyte were added to a polypropylene (PP) container and stirred with an ultrasonic dispersion apparatus (UH-50 manufactured by SMT) for 30 s. The container was then shaken with a shaker (TTM-1 manufactured by Sibata Scientific Technology Ltd.) for 30 min to obtain a solid electrolyte slurry. The obtained slurry was applied onto an Al foil by a blade method using an applicator and dried for 30 min on a hot plate heated to 100° C., whereby a solid electrolyte layer was formed. Three solid electrolyte layers were produced.

### <Assembly of Battery >

The positive electrode current collector layer, the positive electrode active material layer, and a first solid electrolyte layer were laminated in this order. The laminated product was set in a roll press machine and pressed at a pressing pressure of 100 kN/cm and a pressing temperature of 165° C. in first pressing process, whereby a positive electrode laminated body was obtained.

The negative electrode current collector layer, the negative electrode active material layer, and a second solid electrolyte layer were laminated in this order. The laminated product was set in a roll press machine and pressed at a pressing pressure of 60 kN/cm and a pressing temperature of 25° C. in second pressing process, whereby a negative electrode laminated body was obtained.

The negative electrode laminate and the positive electrode laminate were produced so that the area of the negative electrode laminate was larger than the area of the positive electrode laminate.

An Al foil as a release sheet, an intermediate solid electrolyte layer formed on the Al foil, and a negative electrode laminate were laminated so that the solid electrolyte layers were in contact each other. The laminate was set in a flat uniaxial press machine and temporarily pressed at 100MPa and 25° C. for 10 s. The Al foil was peeled off from the intermediate solid electrolyte layer of this laminate, to obtain a negative electrode laminate in which the intermediate solid electrolyte layer was further laminated.

The positive electrode laminate and the negative electrode laminate in which the intermediate solid electrolyte layer was further laminated were laminated so that the solid electrolyte layers were in contact with each other. The laminated body was finally set in the flat uniaxial press machine and pressed at a pressing pressure of 200 MPa and a pressing temperature of 120° C. for 1min in third pressing process. As a result, an all-solid-state battery was obtained.

### <<Evaluation>>

### <Analysis of surface properties of silicon particles>

The carbon content of silicon particles in the Synthetic Examples and Comparative Synthetic examples was measured by high frequency combustion infrared absorption method (equipment used: CSLS600 manufactured by LECO Co.,).

Surface analyses were also performed on silicone particles of each example by time-of-flight secondary ion mass spectrometry (TOF-SIMS) (equipment used: TOF.SIMS5 manufactured by ION-TOF Co., primary ion source: bismuth (Bi)).

### <Measurement of DCIR>

The produced battery was restrained at a predetermined restraint pressure by using a restraint jig, charged at constant current-constant voltage charge (1/100C cut) was performed to 4.55V at 1/10C, and then discharged to 3.0V at 1C.Then, constant current-constant voltage charge (1/100C cut) was performed to 4.35V at 1/3C, and constant current-constant voltage discharge (1/100C cut) was performed to 3.00V at 1/3C. In addition, constant current-constant voltage charge (1/100C cut) was performed to 4.35V at 1/3C, and constant current-constant voltage discharge (1/100C cut) was performed to 3.14V at 1/3C. Thereafter, a 5C constant current was applied for 10 s, and the direct current internal resistance (DCIR) was measured.

### <<Results>>

### <Analysis of Surface Properties Of Silicon Particles>

Table 1 shows the results of quantitative analysis of carbon content of silicone particles of comparative synthetic examples and synthetic examples.

| | Surface | Carbon |
|---|---|---|
| | modification | content |
| | group | [wt %] |
| Comparative Synthetic Example 1 | — | 0.73 |
| Comparative Synthetic Example 2 | —(CH₂)₅CH₃ | 0.91 |
| Synthetic Example1 | -p—C₆H₄(CH₃) | 0.89 |
| Synthetic Example2 | —C₆H₅ | 0.93 |

As shown in Table 1, the silicon particles of the synthesis example had a larger carbon content on the particle surface than the silicon particles of Comparative Synthesis Example 1.

MS spectra derived from p-tolyl group ('p-C₆ H₄ (CH₃) and fenyl group (—C₆ H₅) were confirmed by TOF-SIMS analyses on the silicon particles of the synthetic example (C₇ H₇: m/z=91, C₆ H₅: m/z=77).

From these facts, it is considered that the surface of the silicon particles of the synthetic example could be modified with an aromatic group.

### <Measurement of DCIR>

Tables 2 to 4 show the results of DCIR measurements of the batteries of each example. The value of DCIR is expressed as a relative value when the measurement results of Comparative Example 1 for Examples 1 and 2, and Comparative Example 2, the measurement results of Comparative Example 3 for Example 3, and the measurement results of Comparative Example 4for Comparative Example 5, are each set to 1.00.

TABLE 2

| | Surface | | DCIR |
|---|---|---|---|
| | modification | Conductive | (relative |
| | group | aid | value) |
| Comparative Example 1 | — | SWCNT | 1.00 |
| Comparative Example 2 | —(CH₂)₅CH₃ | SWCNT | 1.02 |
| Example 1 | -p—C₆H₄(CH₃) | SWCNT | 0.82 |
| Example 2 | —C₆H₅ | SWCNT | 0.88 |

TABLE 3

| | Surface | | DCIR |
|---|---|---|---|
| | modification | Conductive | (relative |
| | group | aid | value) |
| Comparative Example 3 | — | MWCNT | 1.00 |
| Example 3 | -p—C₆H₄(CH₃) | MWCNT | 0.90 |

TABLE 4

| | Surface | | DCIR |
|---|---|---|---|
| | modification | Conductive | (relative |
| | group | aid | value) |
| Comparative Example 4 | — | AB | 1.00 |
| Comparative Example 5 | -p—C₆H₄(CH₃) | AB | 0.98 |

As shown in Table 2, the DCIR value of the battery of example in which the surface of the silicon particles were modified with an aromatic group and SWCNT was used as a conductive aid was smaller than the DCIR value of the battery of comparative example in which the silicon particles were unmodified or modified with a cyclic hydrocarbon group. In particular, DCIR value of the battery of Example 1 was the smallest.

As shown in Table 3, the DCIR value of the battery of Example 3 in which the surface of the silicon particles were modified with an aromatic group and MWCNT was used as a conductive aid was smaller than the DCIR value of the battery of Comparative Example 3 in which the silicon particles were unmodified.

As shown in Table 4, the DCIR value of the battery of Comparative Example 5 in which the surface of the silicon particles were modified with an aromatic group and AB was used as a conductive aid was comparable to the DCIR value of battery of Comparative Example 4 in which the silicone particles were unmodified.
1 Lithium ion battery
10 positive electrode current collector layer
20 positive electrode active material layer
30 solid electrolyte layer
40 negative electrode active material layer
50 negative electrode current collector layer

1. A negative electrode mixture,
wherein the negative electrode mixture comprises a surface-modified negative electrode active material particles and a conductive aid,
wherein the surface-modified negative electrode active material particles have silicone particles and an aromatic group modifying a surface of the silicone particles, and
wherein the conductive aid comprises a carbon nanotube.

2. The negative electrode mixture according to claim 1, wherein the aromatic group is a monocyclic aryl group.

3. The negative electrode mixture according to claim 1, wherein the number of carbons of the aromatic group is 4 or more and 10 or less.

4. The negative electrode mixture according to claim 1, wherein the surface-modified negative electrode active material particles have a silicon-oxygen-silicon-carbon bond, the silicon not bonded to the carbon is silicon of the silicon particles, and the carbon is carbon of the aromatic group.

5. A lithium ion battery,
wherein the lithium ion battery comprises a negative electrode active material layer, and
wherein the negative electrode active material layer contains the negative electrode mixture according to claim 1.
